(19) United States
(12) Patent Application Publication
(10) Pub. No.: US 2012/0292561 A1
(43) Pub. Date: Nov. 22, 2012

(54) POSITIVE ELECTRODE ACTIVE MATERIAL FOR NON-AQUEOUS ELECTROLYTE SECONDARY BATTERY, METHOD FOR PRODUCING SAME AND NON-AQUEOUS ELECTROLYTE SECONDARY BATTERY USING SAME

(75) Inventors: Hideo Sasaoka, Niihama-shi (JP); Tomoko Iwanaga, Niihama-shi (JP); Satoshi Matsumoto, Niihama-shi (JP); Yutaka Kawatate, Kadoma-shi (JP); Shinji Arimoto, Kadoma-shi (JP)

(73) Assignees: PANASONIC CORPORATION, Kadoma-shi, Osaka (JP); SUMITOMO METAL MINING CO., LTD., Tokyo (JP)

(21) Appl. No.: 13/574,115

(22) PCT Filed: Jan. 13, 2011
(86) PCT No.: PCT/JP2011/050392

§ 371 Date: Jul. 19, 2012

(30) Foreign Application Priority Data
Jan. 21, 2010 (JP) 2010-011048

(51) Int. Cl. H01M 4/525

(52) U.S. Cl. 252/182.1

(57) ABSTRACT

A positive electrode active material for non-aqueous electrolyte secondary battery composed of a lithium nickel composite oxide having high capacity and superior heat stability, a production method that is suitable for its industrial production, and a non-aqueous electrolyte secondary battery having high safety. The positive electrode active material for non-aqueous electrolyte secondary battery includes a lithium nickel composite oxide having by the following general formula (1):

Li_{b}Ni₁₋ₐM1ₐO₂ (1)

(wherein M1 represents at least one kind of element selected from transition metal elements other than Ni, the second group elements and the thirteenth group elements; a satisfies 0.01≦a≦0.5; and b satisfies 0.85≦b≦1.05). The amount of lithium at the surface of the lithium nickel composite oxide is 0.10% by mass or lower. The positive electrode active material is obtained by water washing fired powder at a temperature range of 10 to 40° C., and then filtering and drying the same.

### TECHNICAL FIELD

The present invention relates to a positive electrode active material for non-aqueous electrolyte secondary battery, a method producing the same and a non-aqueous electrolyte secondary battery using the same, and more specifically the present invention relates to a positive electrode active material for non-aqueous electrolyte secondary battery that satisfies both high capacity and superior heat stability, and enables to provide high output, a method for producing the same, along with a non-aqueous electrolyte secondary battery having high capacity, high output and high safety, using the positive electrode active material.

### BACKGROUND ART

In recent years, with rapid expansion of a compact-type electronic device such as a mobile phone, a notebook-type personal computer, demand of the non-aqueous electrolyte, secondary battery, as a power source enabling charge-discharge, has been increasing rapidly. As the positive electrode active material for the non-aqueous electrolyte secondary battery, a lithium cobalt composite oxide represented by lithium cobaltate (LiCoO₂), as well as the lithium nickel composite oxide represented by lithium nickelate (LiNiO₂), a lithium manganese composite oxide represented by lithium manganate (LiMnO₂) and the like have been widely used.

Lithium cobaltate is expensive due to scarce reserves, and had a problem of containing cobalt, as a major component, which has unstable supply and large price fluctuation. Accordingly, a lithium nickel composite oxide or a lithium manganese composite oxide, containing nickel or manganese as a major component, which is relatively cheap, has been attracted attention in view of cost. However, lithium manganate has many practical problems as a battery, because of having very small charge-discharge capacity, as well as very short charge-discharge cycle characteristics, which indicates battery lifetime, as compared with other materials, although having superior heat stability as compared with lithium cobaltate. On the other hand, lithium nickelate is expected as the positive electrode active material which is capable of producing battery with high energy density in low cost, because of showing larger charge-discharge capacity as compared with lithium cobaltate.

Lithium nickelate is usually produced by mixing and firing a lithium compound and a nickel compound such as nickel hydroxide or nickel oxyhydroxide, and shape thereof includes mono-dispersed powder of primary particles, or powder of secondary particles having void, which is an aggregation of primary particles, however, it had a defect in inferior heat stability in a charged state as compared with lithium cobaltate. That is, pure lithium nickelate has a problem in heat stability or charge-discharge cycle characteristics and the like, and thus it was impossible to be used as a practical battery. This is because of having lower stability of a crystal structure in a charged state, as compared with lithium cobaltate.

As a method for solving this problem, it is general that the lithium nickel composite oxide, having good heat stability and charge-discharge cycle characteristics, is obtained, as a positive electrode active material, by substituting a part of nickel with a transition metal element such as cobalt, manganese, iron, or a foreign element such as aluminum, vanadium, tin, to stabilize a crystalline structure in a state where lithium is by charging (for example, refer to PATENT LITERATURE 1, and NON-PATENT LITERATURE 1). However, in the case of this method, sufficient improvement of heat stability cannot be attained by small amount of element substitution, as well as a large quantity of element substitution causes decrease in capacity, therefore superiority of the lithium nickel composite oxide as a material cannot be well utilized in a battery.

In addition, in the case of the lithium nickel composite oxide, because use thereof as it is after synthesis by firing cannot express sufficiently battery performance in charge-discharge, due to influence of lithium carbonate or lithium sulfate remaining at a grain boundary or the like, removal of impurities by water washing has been performed (for example, refer to PATENT LITERATURE 2). Still more, water washing has been considered as an effective method, because of, other than the above, showing index of true specific surface area by washing off impurities at the surface, and correlating also to heat stability or capacity (for example, refer to PATENT LITERATURE 3). However, also in any of these cases, there was a problem of inability of securing sufficient capacity and output, and superior heat stability only by this, as well as inability of complete utilization of battery performance, because true reason and mechanism thereof have not been clarified sufficiently.

On the other hand, the lithium nickel composite oxide uses an alkali compound such as lithium hydroxide, which reacts with carbon dioxide gas in this synthesis, forming lithium carbonate (LiCO₃), causing gas generation at high temperature, and thus raised a problem of expansion of a battery (for example, refer to NON-PATENT LITERATURE 1). In addition, the lithium nickel composite oxide has strong sensitivity to environment and provided worry of carbonization of lithium hydroxide (LiOH) remained at the surface even after synthesis, and still more generation of lithium carbonate till the step for completion of a positive electrode (for example, refer to NON-PATENT LITERATURE 2).

It should be noted that there have been proposed various evaluation methods of gas generation of the positive electrode active material (for example, refer to PATENT LITERATURES 4 to 6).

However, in PATENT LITERATURE 4, there was a problem that it specified only a water-soluble alkaline component showing lithium hydroxide at the surface, and it cannot specify a lithium carbonate component, which is a factor of high temperature gas generation. In addition, in PATENT LITERATURES 5 and 6, there was a problem that it specified only the lithium carbonate component, and it cannot specify the lithium hydroxide component, which has a possibility to change to lithium carbonate till the step for completion of a positive electrode.

Under these circumstances, there has been required to eliminate the conventional technological problems, and to develop the positive electrode active material for non-aqueous electrolyte secondary battery that satisfies both high capacity and superior heat stability, and still more enables to provide high output, while clarifying true causes incurring defect of battery performance, and mechanism thereof, in the positive electrode active material composed of the lithium nickel composite oxide.

### CITATION LIST

### Patent Literature

PATENT LITERATURE 1: JP-A-5-242891
PATENT LITERATURE 2: JP-A-2003-17054
PATENT LITERATURE 3: JP-A-2007-273108
PATENT LITERATURE 4: JP-A-2009-140787
PATENT LITERATURE 5: JP-A-2008-277087
PATENT LITERATURE 6: JP-A-2009-140909

### Non-Patent Literature

NON-PATENT LITERATURE 1: “High Density Lithium Secondary Battery”, Techno System Co., Ltd., Mar. 14, 1998, pages 61 to 78.
NON-PATENT LITERATURE 2: “Lecture Proceedings of the 47^{th} Battery Symposium”, Nov. 20 to 22, 2006, pages 326 to 327

### SUMMARY OF INVENTION

### Technical Problem

In view of the above conventional technological problems, it is an object of the present invention to provide a positive electrode active material for non-aqueous electrolyte secondary battery that satisfies both high capacity and superior heat stability, and still more enables to provide high output, a method for producing the same, along with a non-aqueous electrolyte secondary battery having high capacity, high output and high safety, using the positive electrode active material, while clarifying true causes incurring defect of battery performance, and mechanism thereof.

### Solution to Problem

The present inventors have intensively studied, in order to attain the above-described objects, on the positive electrode active material for non-aqueous electrolyte secondary battery composed of the lithium nickel composite oxide, and a method for producing the same, and as a result, discovered that battery capacity and high output and gas generation at high temperature of the positive electrode active material are strongly influenced by amount of lithium present at the particle surface of the lithium nickel composite oxide, and a battery having low interior resistance and specified specific surface area, along with high capacity and high output can be obtained, as well as suppression of gas generation at high temperature and superior heat stability can be obtained, by controlling amount of lithium to a specific value or lower. Still more, we have discovered that in that case, it is extremely important to subject fired powder to water washing treatment under specific condition, in order to control amount of lithium present at the particle surface of the lithium nickel composite oxide to the specific value or lower, by which the lithium nickel composite oxide having superior characteristics as the positive electrode active material for non-aqueous electrolyte secondary battery can be obtained, and have thus completed the present invention.

That is, according to a first aspect of the present invention, there is provided a positive electrode active material for non-aqueous electrolyte secondary battery comprising a lithium nickel composite oxide represented by the following general formula (1):

General formula: Li_{b}Ni₁₋ₐO₂ (1)

(wherein M1 represents at least one kind of element selected from transition metal elements other than Ni, the second group elements and the thirteenth group elements; a satisfies 0.01≦a≦0.5; and b satisfies 0.85≦b≦1.05),
characterized in that amount of lithium of a lithium compound present at the surface of the lithium nickel composite oxide is adjusted at 0.10% by mass or lower, relative to total amount.

In addition, according to a second aspect of the present invention, there is provided the positive electrode active material for non-aqueous electrolyte secondary battery, in the first aspect, characterized in that the lithium nickel composite oxide is represented by the following general formula (2):

General formula: Li_{b}Ni_{1-x-y-z}CoₓAl_{y}M2_{z}O₂ (2)

(wherein M2 represents at least one kind of an element selected from Mn, Ti, Ca, and Mg; b satisfies 0.85≦b≦1.05; x satisfies 0.05≦x≦0.30; y is 0.01≦y≦0.1; and z satisfies 0≦z≦0.05).

In addition, according to a third aspect of the present invention, there is provided the positive electrode active material for non-aqueous electrolyte secondary battery, in the first or the second aspect, characterized in that amount of the Lithium is 0.01 to 0.05% by mass.

In addition, according to a fourth aspect, there is provided the positive electrode active material for non-aqueous electrolyte secondary battery, in any one of the first to the third aspects, characterized in that amount of the lithium is mass ratio of lithium relative to the lithium nickel composite oxide, which was obtained, after making slurry of the lithium nickel composite oxide by adding into a solution, and considering a lithium compound present at the surface as an total alkaline component in the slurry, determining amount of the alkaline component (the lithium compound) by titration of pH of the slurry using an acid, and then by converting to lithium therefrom.

In addition, according to a fifth aspect, there is provided the positive electrode active material for non-aqueous electrolyte secondary battery, in the fourth aspect, characterized in that the acid is at least one kind selected from the group consisting of hydrochloric acid, sulfuric acid, nitric acid and an organic acid.

In addition, according to a sixth aspect, there is provided a method for producing the positive electrode active material for non-aqueous electrolyte secondary battery, in any one of the first to the fifth aspects, characterized by comprising:

(a) a step for preparing fired powder of the lithium nickel composite oxide represented by the following composition formula (3):

Composition formula: Li_{b}Ni₁₋ₐM1ₐO₂ (3)

(wherein M1 represents at least one kind of an element selected from transition metal elements other than Ni, the second group elements, and the thirteenth group elements; a satisfies 0.01≦a≦0.5; and b satisfies 0.95≦b≦1.13), by mixing at least one kind of a nickel compound selected from a nickel hydroxide containing nickel as a major component, and at least one kind of an element selected from other transition metal elements, the second group elements, and the thirteenth group elements, as a minor component, a nickel oxyhydroxide thereof, and a nickel oxide obtained by roasting them, and a lithium compound, and then firing them at the maximum temperature in a range of 650 to 850° C., under oxygen atmosphere.

(b) a step for preparing powder of the lithium nickel composite oxide by water washing treatment of the fired powder at a temperature of 10 to 40° C., and at slurry concentration sufficient for amount of lithium of the lithium compound present at the surface of the lithium nickel composite oxide to become 0.10% by mass or lower, relative to total amount, and then by filtering and drying the same.

In addition, according to a seventh aspect, there is provided the method for producing the positive electrode active material for non-aqueous electrolyte secondary battery, in the sixth aspect, characterized in that the nickel hydroxide is prepared by dropping an aqueous solution of a metal compound which contains a nickel as a main component, and at least one kind of an element selected from other transition metal element, the second group element and the thirteenth group element as a minor component; and an aqueous solution which contains an ammonium ion supplying substance, into a reaction chamber warmed, wherein an aqueous solution of an alkali metal hydroxide, in an amount sufficient to maintain a reaction solution in an alkaline state, is dropped optionally, as appropriate.

In addition, according to an eighth aspect of the present invention, there is provided the method for producing the positive electrode active material for non-aqueous electrolyte secondary battery, in the sixth or the seventh aspect, characterized in that the nickel oxyhydroxide is prepared by dropping an aqueous solution of a metal compound which contains a nickel as a main component, and at least one kind of an element selected from other transition metal element, the second group element and the thirteenth group element as a minor component; and an aqueous solution which contains an ammonium ion supplying substance, into a reaction chamber warmed, wherein an aqueous solution of an alkali metal hydroxide, in an amount sufficient to maintain a reaction solution in an alkaline state, is dropped optionally, as appropriate, and subsequently by further adding an oxidizing agent.

In addition, according to a ninth aspect, there is provided the method for producing the positive electrode active material for non-aqueous electrolyte secondary battery, in any one of the sixth to the eighth aspects, characterized in that the lithium compound is at least one kind selected from the group consisting of a hydroxide, an oxyhydroxide, an oxide, a carbonate salt, a nitrate salt and a halide of lithium.

In addition, according to a tenth aspect, there is provided the method for producing the positive electrode active material for non-aqueous electrolyte secondary battery, in any one of the sixth to the ninth aspects, characterized in that mixing ratio of the nickel compound and the lithium compound, in the step (a), is set so that amount of lithium in the lithium compound becomes 0.95 to 1.13 in molar ratio, relative to total amount of nickel in the nickel compound and transition metal elements other than Ni, the second group elements, and the thirteenth group elements.

In addition, according to an eleventh aspect, there is provided the method for producing the positive electrode active material for non-aqueous electrolyte secondary battery, in any one of the sixth to the tenth aspects, characterized in that amount of the fired powder, contained in slurry in water washing treatment, in the step (b), is 500 g to 2000 g, relative to 1 L of water.

In addition, according to a twelfth aspect, there is provided the method for producing the positive electrode active material for non-aqueous electrolyte secondary battery, in the eleventh aspect, characterized in that amount of the fired powder, contained in slurry in water washing treatment, in the step (b), satisfies the following formula (4), relative to 1 L of water:

500≦B≦−15000A+17000 (4)

(wherein A represents ratio of molar amount of lithium in the lithium compound, relative to total mole amount of nickel in the nickel oxide and transition metal elements other than Ni, the second group elements, and the thirteenth group elements, and 1.0≦A≦1.1; and B represents amount (g) of the fired powder contained in slurry, relative to 1 L of water).

In addition, according to a thirteenth aspect, there is provided the method for producing the positive electrode active material for non-aqueous electrolyte secondary battery, in any one of the sixth to the twelfth aspects, characterized in that, in the step (b), the fired powder after water washing treatment is dried, under gas atmosphere not containing a compound component containing carbon, or under vacuum atmosphere.

In addition, according to a fourteenth aspect, there is provided a non-aqueous electrolyte secondary battery made by using the positive electrode active material for non-aqueous electrolyte secondary battery, in any one of the first to the fifth aspects.

### Advantageous Effects of Invention

According to the present invention, the positive electrode active material for non-aqueous electrolyte secondary battery that is superior in high capacity and heat stability, and enables to provide high output, composed of the lithium nickel composite oxide, when used as a battery, can be obtained. In addition, a method for producing the same is easy and has high productivity, and thus industrial value thereof is extremely high.

### BRIEF DESCRIPTION OF DRAWINGS

FIG. 1 is a cross-sectional view showing a schematic structure of a 2032-type coin battery.

### REFERENCE SIGNS LIST

1 Positive electrode (electrode for evaluation)
2 Separator (impregnated with the electrolytic solution)
3 Lithium metal negative electrode
4 Gasket
5 Positive electrode can
6 Negative electrode can

### DESCRIPTION OF EMBODIMENTS

Explanation will be given below in detail on the positive electrode active material for non-aqueous electrolyte secondary battery, the method for producing the same and the non-aqueous electrolyte secondary battery using the same of the present invention.

### 1. The Positive Electrode Active Material for Non-Aqueous Electrolyte Secondary Battery

The positive electrode active material for non-aqueous electrolyte secondary battery of the present invention (hereafter, it may also be abbreviated as the positive electrode active material of the present invention) is the positive electrode active material comprising the lithium nickel composite oxide represented by the following general formula (1):

General formula: Li_{b}Ni₁₋ₐM1ₐO₂ (1)

(wherein M1 represents at least one kind of element selected from transition metal elements other than Ni, the second group elements and the thirteenth group elements; a satisfies 0.01≦a≦0.5; and b satisfies 0.85≦b≦51.05),
characterized in that amount of lithium of a lithium compound present at the surface of the lithium nickel composite oxide is adjusted at 0.10% by mass or lower, relative to total amount.

The lithium nickel composite oxide is not especially limited, as long as it is a compound represented by the composition formula (1), however, among them, a lithium nickel composite oxide represented by the following general formula (2) is preferable:

General formula: Li_{b}Ni_{1-x-y-z}CoₓAl_{y}M2_{z}O₂ (2)

(wherein M2 represents at least one kind of an element selected from Mn, Ti, Ca, and Mg; b satisfies 0.85≦b≦1.05; x satisfies 0.05≦x≦0.30; y is 0.01≦y≦0.1; and z satisfies 0≦z≦0.05).

Presence of lithium carbonate at the surface of the positive electrode active material composed of the lithium nickel composite oxide emits gas by decomposition of the lithium carbonate when a battery is used by being maintained at a high temperature state, and decreases safety due to expansion of the battery. Therefore, it is necessary to decreases an amount of lithium carbonate at the surface of the positive electrode active material as low as possible. However, it is not sufficient only to decrease the amount of lithium carbonate at the surface of the positive electrode active material at production.

That is, in the lithium nickel composite oxide composing the positive electrode active material of the present invention, generally, excess impurities such as lithium carbonate, lithium sulfate, or lithium hydroxide remain at the surface thereof or a crystal grain boundary. Lithium hydroxide at the surface reacts with carbon dioxide gas in atmosphere to be converted to lithium carbonate, after production of the positive electrode active material and till being incorporated into a battery, and thus lithium carbonate at the surface of the positive electrode active material increases more than just after production. Therefore, it is impossible to suppress gas generation at high temperature, unless amount of lithium hydroxide is controlled, in addition to amount of lithium carbonate at the surface of the positive electrode active material.

In the present invention, the amount of lithium means mass ratio in which lithium of the lithium compound present at the surface of the particles of the lithium nickel composite oxide occupies in total amount of the particles of the lithium nickel composite oxide, and by controlling said amount of lithium to 0.10% by mass or lower, suppression of gas generation at high temperature is made possible. At the surface of the positive electrode active material, a lithium compound is present other than lithium hydroxide and lithium carbonate, however, in the case of production under usual condition, most parts thereof are lithium hydroxide and lithium carbonate, and by controlling them as the amount of lithium present at the surface of the positive electrode active material, gas generation at high temperature can be suppressed.

The amount of lithium over 0.10% by mass increases lithium carbonate, when the positive electrode active material is used as a battery, and increases amount of gas generation by decomposition, when it is exposed in a high temperature state, resulting in expansion of the battery. It is more preferable that the amount of lithium is 0.05% by mass or lower.

On the other hand, the lower limit of the amount of lithium is not especially limited, however, it is preferable to be 0.01% by mass or higher. The amount of lithium below 0.01% by mass may sometimes provides a state that the lithium nickel composite oxide is washed excessively. That is, in the case where powder of the lithium nickel composite oxide is washed excessively, the lithium compound becomes a state of being little present at the surface.

However, the amount of lithium is the one determined in a way as will be described later, and there may be the case where lithium of below 0.01% by mass is detected as the amount of lithium, by elution of trace amount of lithium from inside of the lithium nickel composite oxide. In the case of excess washing, such a problem is raised that lithium at the vicinity of a crystal of the lithium nickel composite oxide is desorbed to form NiO where Li is lost, or NiOOH where Li is substituted with H, at the surface layer, both of which have high electric resistance and thus increase resistance of the particle surface, as well as decrease Li in the lithium nickel composite oxide, and decrease capacity.

It should be noted that the amount of lithium in the lithium compound present at the surface of powder of the lithium nickel composite oxide can be determined quantitatively by titration of an acid using pH of the slurry as an index, after adding a solvent to said lithium nickel composite oxide to make slurry, and from this result, mass ratio of lithium present at the above surface, relative to the lithium nickel composite oxide, can be determined.

That is, in the titration, an alkali component in the slurry is quantitatively determined, and said alkali component is considered lithium in the lithium compound such as lithium hydroxide, lithium carbonate (including sodium hydrogencarbonate) at the powder surface, excluding impurities contained in powder of the lithium nickel composite oxide. Therefore, by considering the alkaline component determined quantitatively by titration in the neutralization, as lithium in the lithium compound present at the surface of powder, mass ratio of said lithium, relative to the lithium nickel composite oxide, can be determined as the amount of lithium.

To prevent contamination of impurities into slurry, it is preferable to use pure water, for example, water with 1 μS/cm or lower, and more preferably 0.1 μS/cm or lower, as the solvent, and as for the slurry concentration, it is preferable to set ratio of a solvent at 5 to 100, relative to one portion of powder of the lithium nickel composite oxide, in mass ratio, so as to sufficiently dissolve the lithium compound at the surface of the lithium nickel composite oxide in the solvent, and make operation in titration easy. In addition, the acid may also be any acid to be used usually in titration, and it is preferable to be at least one kind selected from the group consisting of hydrochloric acid, sulfuric acid, nitric acid and an organic acid.

As condition of the titration, any condition may be adopted as used in titration for an alkaline solution using pH as an index, and an equivalence point can be determined from inflection point of pH. For example, the equivalence point of lithium hydroxide is around pH 8, and the equivalence point of lithium carbonate is around pH 4.

Next, explanation will be given on properties and the like of the positive electrode active material of the present invention.

The positive electrode active material of the present invention is a positive electrode active material composed of powder of the lithium nickel composite oxide, and is obtained, for example, by water washing, at a temperature of 10 to 40° C., fired powder having the following composition formula (3):

Composition formula: Li_{b}Ni₁₋ₐM1ₐO₂ (3)

(wherein M1 represents at least one kind of an element selected from transition metal elements other than Ni, the second group elements, or the thirteenth group elements; a satisfies 0.01≦a≦0.5; and b satisfies 0.95≦b≦1.13), and then by filtering and drying the same.

In general, in the case of using the lithium nickel composite oxide as the positive electrode active material for a secondary battery, excess impurities such as lithium carbonate, lithium sulfate, or lithium hydroxide generally remain at the surface thereof or a crystal grain boundary, and a lithium ion secondary battery using this has high internal resistance in a battery, and cannot sufficiently exert performance, which a material has, for battery capacity such as charge-discharge efficiency or cycle performance. On the contrary, performing removal of impurity components at the surface or a grain boundary, by water washing treatment or the like, decreases internal resistance and makes possible to sufficiently exert own battery performance.

The positive electrode active material of the present invention provides a battery with high output, by removal of impurity components by the water washing treatment at a temperature of 10 to 40° C., resulting in significant decrease in internal resistance and a battery with high output, when used as a positive electrode of a battery. Specific surface area of the positive electrode active material of the present invention after water washing treatment is preferably 0.3 to 2.5 m²/g, and more preferably 0.5 to 2.05 m²/g. That is, the specific surface area of powder after water washing treatment over 2.5 m²/g abruptly increases heat generation amount by a reaction with an electrolytic solution, which may incur decrease in heat stability. On the other hand, the specific surface area below 0.3 m²/g may decrease capacity and output characteristics of a battery, although enables to suppress heat generation.

In addition, moisture content of powder after the drying is preferably 0.2% by mass or lower, more preferably 0.1% by mass, and still more preferably 0.05% by mass. That is, it is because the moisture content of powder over 0.2% by mass absorbs gas components containing carbon and sulfur in atmosphere, and provides a chance for generation of a lithium compound at the surface, causing gas generation at high temperature. It should be noted that measurement value of moisture content is the one measured using a Carl Fischer moisture meter.

Still more, the positive electrode active material of the present invention is preferably a single-phase of the lithium nickel composite oxide having a hexagonal layer-like structure (hereafter it may be simply described as a single-phase of the lithium nickel composite oxide). Presence of a foreign phase deteriorates battery characteristics.

Explanation will be given below on additive elements composing the lithium nickel composite oxide represented by the general formula (2), and addition amount thereof.

### a) Co

Co is an additive element contributing to enhancement of cycle characteristics, and a value x smaller than 0.05 cannot provide sufficient cycle characteristics, resulting in decrease in capacity retention rate as well. In addition, the value x over 0.3 results in larger decrease in initial discharge capacity.

### b) Al

Al is an additive element having effect to improve safety, and a value y, which shows addition amount, smaller than 0.01 is too low addition amount and provides too low effect, while the value y over 0.1 enhances safety in response to addition amount, however, decreases charge-discharge capacity, and thus it is not preferable. To suppress decrease in charge-discharge capacity, it is preferable to set it at 0.01 to 0.05.

### c) M2

M2, which is an additive element, is at least one kind of element selected from Mn, Ti, Ca and Mg, and can be added to enhance cycle characteristics or safety. A value z over 0.05 largely decreases initial discharge capacity, although more enhances stabilization of a crystal structure, and it is thus not preferable.

The positive electrode active material of the present invention is a superior positive electrode active material for non-aqueous electrolyte secondary battery because of providing capacity as high as 180 mAh/g or higher, and more preferably 185 mAh/g or higher, as well as suppressing gas generation at high temperature, reading to high safety, when used as a battery.

### 2. The Production Method of the Positive Electrode Active Material for Non-Aqueous Electrolyte Secondary Battery

The production method of the positive electrode active material of the present invention is characterized by being composed of the following step (a) and (b):

(a) a step for preparing fired powder of the lithium nickel composite oxide represented by the following composition formula (3):

Composition formula (3): Li_{b}Ni₁₋ₐM1ₐO₂ (3)

(wherein M1 represents at least one kind of an element selected from transition metal elements other than Ni, the second group elements, and the thirteenth group elements; a satisfies 0.01≦a≦0.5; and b satisfies 0.95≦b≦1.13), by mixing at least one kind of a nickel compound, selected from a nickel hydroxide containing nickel as a major component, and at least one kind of an element selected from other transition metal elements, the second group elements, and the thirteenth group elements, as a minor component, a nickel oxyhydroxide thereof, and a nickel oxide obtained by roasting them, and a lithium compound, and then firing them at the maximum temperature in a range of 650 to 850° C., under oxygen atmosphere (hereafter, it may also be abbreviated simply as the step (a), or the firing step).

(b) a step for preparing powder of the lithium nickel composite oxide by water washing treatment of the fired powder at a temperature of 10 to 40° C., and at slurry concentration sufficient for amount of lithium of the lithium compound present at the surface of the lithium nickel composite oxide to become 0.10% by mass or lower, relative to total amount, and then by filtering and drying the same (hereafter, it may also be abbreviated simply as the step (b), or the step for water washing and drying)

Explanation will be given below by each step.

### (a) The Firing Step

The step of (a) is a step for preparing fired powder of the lithium nickel composite oxide represented by the above composition formula (1), by mixing at least one kind of a nickel compound selected from a nickel hydroxide containing nickel as a major component, and at least one kind of an element selected from other transition metal elements, the second group elements, and the thirteenth group elements, as a minor component, a nickel oxyhydroxide thereof, and a nickel oxide obtained by roasting them, and a lithium compound, and then firing them at the maximum temperature in a range of 650 to 850° C., under oxygen atmosphere.

The nickel compound to be used in the above step (a) is selected from a nickel hydroxide containing nickel as a major component, and at least one kind of an element selected from other transition metal elements, the second group elements, and the thirteenth group elements, as a minor component, a nickel oxyhydroxide thereof, and a nickel oxide obtained by roasting them.

To obtain the above positive electrode active material, the lithium nickel composite oxide obtained by various methods can be used, however, among them, the one which is obtained by mixing a nickel compound, where metal elements other than lithium are dissolved or dispersed by a crystallization method, and a lithium compound, and then firing them, is preferable.

That is, in general, typical production method of the lithium nickel composite oxide includes a method for mixing and firing the nickel compound, where metal elements other than lithium are dissolved or dispersed by a crystallization method, and a lithium compound, as raw materials; a method for subjecting a mixed solution of all aqueous solutions containing desired metal elements to spray pyrolysis treatment; and a method for pulverization mixing of all desired metal elements by mechanical pulverization such as a ball mill, and then firing them.

However, among them, methods other than producing a nickel raw material by the crystallization method are not efficient, due to raising a problem of heat stability, because the resultant lithium nickel composite oxide has very large specific surface area. Moreover, use of crystallization method is capable of producing nickel hydroxide or nickel oxyhydroxide, which is a nickel compound forming highly bulky spherical particles suitable as the positive electrode active material, therefore it is also advantageous in filling property, including nickel oxide obtained by roasting it, and thus the crystallization method is most suitable for producing the lithium nickel composite oxide.

Nickel hydroxide to be used in the above step (a) is not especially limited, and the one obtained by the crystallization method under various conditions may be used, however, among these, the preferable one is the one which is prepared by dropping an aqueous solution of a metal compound which contains nickel as a major component, and at least one kind of an element selected from other transition metal elements, the second group elements and the thirteenth group elements as a minor component; and an aqueous solution which contains an ammonium ion supplying substance, into a reaction chamber warmed at preferably 40 to 60° C., wherein an aqueous solution of an alkali metal hydroxide, in an amount sufficient to maintain a reaction solution in an alkaline state, preferably at a pH of 10 to 14, is dropped optionally, as appropriate. That is, nickel hydroxide produced by this method is highly bulky powder, therefore it is suitable as a raw material of the lithium nickel composite oxide to be used for the positive electrode active material for non-aqueous electrolyte secondary battery.

That is, the temperature over 60° C. or pH over 14 increases priority of nucleus formation in liquid, which inhibits crystal growth and provides only fine powder. On the other hand, the temperature below 40° C. or pH below 10 decreases nucleus generation in liquid, and increases priority of crystal growth of the particles, which raises a problem of formation of such a very large particle as forms a concave-convex in preparation of an electrode, or increases residual amount of metal ions in a reaction solution, leading to extremely poor reaction efficiency.

The nickel oxyhydroxide to be used in the above step (a) is not especially limited, however, the one which is prepared by further adding an oxidizing agent such as sodium hyperchlorite, hydrogen peroxide to the nickel hydroxide, is preferable. That is, nickel hydroxide produced by this method is highly bulky powder, therefore it is suitable as a raw material of the lithium nickel composite oxide to be used for the positive electrode active material for non-aqueous electrolyte secondary battery.

The nickel oxide to be used in the above step (a) is not especially limited, however, the one which is obtained by roasting the above nickel hydroxide or nickel oxyhydroxide, is preferable. Roasting condition of the nickel hydroxide or nickel oxyhydroxide is not especially limited, and it is desirable that roasting is performed, for example, under air atmosphere at a temperature of preferably 500 to 1100° C., and more preferably 600 to 1000° C.

In this case, the roasting temperature below 500° C. provides difficulty in quality stabilization of the lithium nickel composite oxide obtained by using this, and easily provides compositional disproportionation in synthesis. On the other hand, the roasting temperature over 1100° C. provides abrupt particle growth of primary particles composing the particle, and too small reaction area of the nickel compound side in preparation of the subsequent lithium nickel composite oxide, which thus inhibits a reaction with lithium, and raises a problem of separation caused by specific gravity, that is, into a nickel compound with larger specific gravity at the lower layer, and a lithium compound in a molten state at the upper layer.

In the production method of the present invention, fired powder of the lithium nickel composite oxide, represented by the above composition formula (1), is prepared by mixing at least one kind of a nickel compound, selected from a nickel hydroxide, a nickel oxyhydroxide thereof, and a nickel oxide, obtained by roasting them, and a lithium compound, and then firing them at the maximum temperature in a range of 650 to 850° C., under oxygen atmosphere.

In the above mixing, a dry-type mixing machine or a mixing granulation apparatus such as a V blender is used, and in addition, in the above firing, a firing furnace such as an electric furnace, a kiln, a tubular furnace, a pusher furnace is used, which is adjusted to have oxygen atmosphere, or gas atmosphere having an oxygen concentration of 20% by mass or higher, such as dried air atmosphere after treatment of dehumidification and removal of carbon dioxide gas.

The above lithium compound is not especially limited, however, at least one kind selected from the group consisting of a hydroxide, an oxyhydroxide, an oxide, a carbonate salt, a nitrate salt and a halide of lithium is used.

Mixing ratio of the nickel compound and the lithium compound, in the above step (a), is not especially limited, however, it is preferable to be adjusted, for example, so that amount of lithium in the lithium compound becomes 0.95 to 1.13, in molar ratio, relative to total amount of nickel in the nickel compound and other transition metal elements, the second group elements, and the thirteenth group elements.

That is, the above molar ratio below 0.95 also provides the molar ratio of the resultant fired powder of below 0.95, leading to very poor crystallinity, as well as provides molar ratio (b) of lithium and a metal other than lithium, after water washing, below 0.85, causing large decrease in battery capacity in charge-discharge cycle. On the other hand, the molar ratio over 1.13 provides also molar ratio of the resultant fired powder over 1.13, giving a large quantity of excess lithium compound present at the surface, which makes difficult removal of this by water washing. Therefore, use of this as the positive electrode active material not only provides a large quantity of gas generation in charging of a battery but also provides a reaction with a material, such as an organic solvent to be used in preparation of an electrode, because of being powder showing high pH, causing a trouble by gelling of slurry. In addition, it provides molar ratio (b) over 1.05 after water washing, resulting in increased internal resistance of a positive electrode as a battery.

In addition, as firing temperature, the maximum temperature in a range of 650 to 850° C., and preferably in a range of 700 to 780° C. is used. That is, heat treatment at such a temperature as over 500° C. forms lithium nickelate, however, the temperature below 650° C. provides undeveloped crystal thereof and an unstable structure, leading to easy destruction of the structure by phase transition or the like by charge-discharge. On the other hand, the temperature over 850° C. destroys a layer-like structure, resulting in difficulty of insertion or elimination of lithium ions, or still more forms nickel oxide or the like by decomposition. Still more, also to attain a uniform reaction in a temperature region where crystal growth progresses, after removing crystal water or the like of the lithium compound, it is particularly preferable to perform firing in two stages, that is, at a temperature of 400 to 600° C. for one hour or longer, and subsequently at a temperature of 650 to 850° C. for three hours or longer.

### (b) The Step for Water Washing and Drying

The step of (b) is a step for filtering and drying after water washing the above fired powder.

Here, in water washing treatment of the fired powder, it is important that temperature range is 10 to 40° C., and preferably 15 to 30° C., and also amount of lithium of the lithium compound present at the surface of the lithium nickel composite oxide has a slurry concentration sufficient to become 0.10% by mass or lower relative to total amount, that is, amount of the fired powder contained in slurry in water washing treatment, is 500 g to 2000 g, relative to 1 L of water. Still more, it is preferable that amount of the fired powder contained in slurry in water washing treatment satisfies the following formula (4), relative to 1 L of water:

500≦B≦−15000A+17000 (4)

(wherein A represents ratio of molar amount of lithium in the lithium compound, relative to total mole amount of nickel in the nickel oxide and transition metal elements other than Ni, the second group elements, and the thirteenth group elements, and 1.0≦A≦1.1; and B represents amount (g) of the fired powder contained in slurry, relative to 1 L of water).

By setting the temperature in water washing treatment at 10 to 40° C., amount of lithium present at the surface of powder of the lithium nickel composite oxide can be made at 0.1% by mass or lower, and gas generation at high temperature can be suppressed. In addition, not only the positive electrode active material attainable high capacity and high output can be obtained, but also high safety can be attained at the same time.

On the contrary, the temperature in water washing below 10° C. does not remove impurities adhered at the surface of the fired powder, due to insufficient washing, thus remaining a large quantity of them. These impurities include lithium carbonate and lithium hydroxide, and amount of lithium present at the surface of powder of the lithium nickel composite oxide is over 0.10% by mass, leading to a state of easy gas generation in storage at high temperature. In addition, remaining of the impurities increases surface resistance and increases resistance value in using it as a positive electrode of a battery. Still more, it results in too small specific surface area.

On the contrary, the temperature in water washing over 40° C. increases elution amount of lithium from the fired powder and increases lithium concentration in the washing solution, thus increases lithium adhered again as lithium hydroxide at the powder surface, and amount of lithium present at the surface becomes over 0.10% by mass. In addition, it increases excessively specific surface area after water washing treatment, which increases heat generation amount by a reaction with an electrolytic solution, and incurs decrease in heat stability. Additionally, there are formed NiO, where Li is lost, or NiOOH, where Li is substituted with H, at the surface layer, both of which have high electric resistance and thus increase resistance of the particle surface, as well as decrease Li in the lithium nickel composite oxide, and decrease capacity.

In addition, water washing time is not especially limited, however, it is necessary to be time enough so that amount of lithium of the lithium compound present at the surface of the lithium nickel composite oxide becomes 0.10% by mass or lower, relative to total amount, ant it is usually 20 minutes to 2 hours, although it is not determined unconditionally, because of dependence on temperature of water washing.

As slurry concentration in water washing, it is preferable that amount (g) of the fired powder contained in slurry is 500 g to 2000 g, relative to 1 L of water, and it is more preferable that it satisfies the above formula (4). That is, the higher slurry concentration provides the more amount of powder, and the concentration over 2000 g/L not only makes stirring difficult, due to very high viscosity, but also slows down dissolution rate of an adhered substance from relation of equilibrium, due to a high alkaline state in liquid, or makes separation difficult from powder even when peeling occurs. On the contrary, when the slurry concentration is below 500 g/L, a large quantity of elution of lithium is made, due to too low concentration, amount of lithium at the surface decreases, however, also elimination of lithium occurs from a crystal lattice of the positive electrode active material, and thus not only destruction of the crystal becomes easy but also carbon dioxide gas in air is absorbed by a high pH aqueous solution to re-deposit lithium carbonate. In addition, in consideration of productivity in an industrial view point, it is desirable that slurry concentration is 500 to 2000 g/L, in view of capability or workability of equipment.

Further, water to be used is not especially limited, however, water with an electric conductivity measured below 10 μS/cm is preferable, and water with 1 μS/cm or lower is more preferable. That is, water with an electric conductivity below 10 μS/cm is capable of preventing decrease in battery performance, caused by adhering of impurities onto the positive electrode active material.

It is preferable that adhered water remaining at the particle surface, in solid-liquid separation of the above slurry, is less. When adhered water increases, lithium dissolved in a solution re-deposits, and amount of lithium present at the surface of powder of the lithium nickel composite oxide increases. It is preferable that adhered water is usually 1 to 10% by mass, relative to powder of the lithium nickel composite oxide.

Temperature of the above drying is not especially limited, however, it is preferably 80 to 700° C., more preferably 100 to 550° C., and still more preferably 120 to 350° C. That is, reason for setting the temperature at 80° C. or higher is because of preventing generation of lithium concentration gradient between the surface of the particle and the inside of the particle, by drying the positive electrode active material quickly after water washing. On the other hand, it is estimated that the vicinity of the surface of the positive electrode active material is in an extremely near stoichiometry state, or a state near a charged state by elimination of some amount of lithium, and thus the temperature over 700° C. may provide a chance of destruction of a crystal structure of powder in a near charged state, providing worry of incurring decrease in electric characteristics. In addition, to reduce worry in view of property and characteristics of the positive electrode active material after water washing, it is desirable that the temperature is 100 to 550° C., and still more, in consideration of also productivity and thermal energy cost, it is more desirable that the temperature is 120 to 350° C. In this case, as a drying method, it is preferable to perform drying powder after filtration, at predetermined temperature, using a drying machine which is controllable under gas atmosphere not containing a compound component including carbon and sulfur, or under vacuum atmosphere.

### 3. The Non-Aqueous Electrolyte Secondary Battery

The non-aqueous electrolyte secondary battery of the present invention is the non-aqueous electrolyte secondary battery having large capacity and high safety, by preparing the positive electrode using the positive electrode active material composed of the above lithium nickel composite oxide, in particular, the lithium nickel composite oxide obtained by the above production method as the positive electrode active material, and incorporating this.

It should be noted that, according to the present invention, because of enhancement of characteristics of an active substance itself, performance of a battery obtained using the same is not influenced by its shape. That is, battery shape is not limited to the coin battery shown in Examples, and it may be a cylinder-type battery obtained by winding a band-like positive electrode or a negative electrode via a separator, or a square-type battery.

Explanation will be given next on the preparation method for the positive electrode to be used in the non-aqueous electrolyte secondary battery of the present invention, however, the method is not especially limited thereto. For example, the positive electrode may be prepared in which the positive electrode mixture containing the positive electrode active material particle and the binding agent is supported on a band-like positive electrode core material (positive electrode collector). It should be noted that other additives such as an electric conductive material can be contained as arbitrary components, into the positive electrode mixture. Supporting of the positive electrode mixture on the core material is performed by preparing a paste where the positive electrode mixture is dispersed in a liquid component, and by applying the paste onto the core material and drying it.

As the binding agent of the positive electrode mixture, any of a thermoplastic resin or a thermosetting resin may be used, however, the thermoplastic resin is preferable. As the thermoplastic resin, there is included, for example, polyethylene, polypropylene, polytetrafluoroethylene (PTFE), polyvinylidene fluoride (PVDF), a styrene-butadiene rubber, tetrafluoroethylene-hexafluoropropylene copolymer (FEP), a tetrafluoroethylene-perfluoroalkyl vinyl ether copolymer (PFA), vinylidene fluoride-hexafluoropropylene copolymer, a vinylidene fluoride-chlorotrifluoroethylene copolymer, an ethylene-tetrafluoroethylene copolymer (ETFE), polychlorotrifluoroethylene (PCTFE), a vinylidene fluoride-pentafluoropropylene copolymer, a propylene-tetrafluoroethylene copolymer, an ethylene-chlorotrifluoroethylene copolymer (ECTFE), a vinylidene fluoride-hexafluoropropylene-tetrafluoroethylene copolymer, a vinylidene fluoride-perfluoromethyl vinyl ether-tetrafluoroethylene copolymer, an ethylene-acrylic acid copolymer, an ethylene-methacrylic acid copolymer, an ethylene-methyl acrylate copolymer, an ethylene-methyl methacrylate copolymer or the like. They may be used alone or two or more kinds in combination. In addition, they may be cross-linked substances by Na⁺ ion or the like.

As the electric conducting material of the positive electrode mixture, any one may be used as long as it is an electron conductive material which is chemically stable in a battery. For example, there may be used graphites such as natural graphite (scale-like graphite, or the like), artificial graphite; carbon blacks such as acetylene black, Ketjen black, channel black, furnace black, lamp black, thermal black; conductive fibers such as carbon fiber, metal fiber; metal powders such as alminum; conductive whiskers such as zinc oxide, potassium titanate; a conductive metal oxide such as titanium oxide; and organic conductive material such as a polyphenylene derivative; carbon fluoride or the like. They may be used alone or two or more kinds in combination.

The addition amount of the electric conducting material of the positive electrode mixture is not especially limited, and it is preferably 0.5 to 50% by weight, more preferably 0.5 to 30% by weight, and still more preferably 0.5 to 15% by weight, relative to the positive electrode active material particle contained in the positive electrode mixture.

As the positive electrode core material (the positive electrode collector), any one may be used as long as it is an electron conductive material which is chemically stable in a battery. For example, a foil or a sheet composed of aluminum, stainless steel, nickel, titanium, carbon, a conductive resin or the like can be used, and among these, the aluminum foil, the aluminum alloy foil and the like are more preferable. In this case, it is also possible to furnish a carbon or titanium layer, or form an oxide layer at the surface of the foil or the sheet. In addition, it is also possible to furnish a concave-convex at the surface of the foil or the sheet, and a net, a punching sheet, a lath substance, a porous substance, a foamed substance, a fiber group compact and the like may also be used.

Thickness of the positive electrode core material is not especially limited, and, for example, 1 to 500 μm is used.

Explanation will be given next on composition elements other than the positive electrode, to be used in the non-aqueous electrolyte secondary battery of the present invention.

It should be noted that the non-aqueous electrolyte secondary battery of the present invention has characteristics in using the above positive electrode active material, and other composition elements are not especially limited.

Firstly, as a negative electrode, the one capable of charging and discharging lithium is used, and the one, for example, containing a negative electrode active material and binding agent and supporting a negative electrode mixture containing an electric conductive material or a thickener as an arbitrary component on a negative electrode core material may be used. Such a negative electrode may be produced by a similar method as in the positive electrode.

As the negative electrode active material, any one may be used as long as it is a material capable of electrochemically charging and discharging lithium. For example, graphite, a non-graphitizing carbon material, a lithium alloy or the like may be used. As the lithium alloy, it is preferable to be an alloy containing at least one kind of an element selected from the group consisting of silicon, tin, aluminum, zinc and magnesium.

Average particle diameter of the negative electrode active material is not especially limited, and, for example, 1 to 30 μm is used.

As the binding agent of the negative electrode mixture, any of a thermoplastic resin or a thermosetting resin may be used, however, the thermoplastic resin is preferable. As the thermoplastic resin, there is included, for example, polyethylene, polypropylene, polytetrafluoroethylene (PTFE), polyvinylidene fluoride (PVDF), a styrene-butadiene rubber, tetrafluoroethylene-hexafluoropropylene copolymer (FEP), a tetrafluoroethylene-perfluoroalkyl vinyl ether copolymer (PFA), vinylidene fluoride-hexafluoropropylene copolymer, a vinylidene fluoride-chlorotrifluoroethylene copolymer, an ethylene-tetrafluoroethylene copolymer (ETFE), polychlorotrifluoroethylene (PCTFE), a vinylidene fluoride-pentafluoropropylene copolymer, a propylene-tetrafluoroethylene copolymer, an ethylene-chlorotrifluoroethylene copolymer (ECTFE), a vinylidene fluoride-hexafluoropropylene-tetrafluoroethylene copolymer, a vinylidene fluoride-perfluoromethyl vinyl ether-tetrafluoroethylene copolymer, an ethylene-acrylic acid copolymer, an ethylene-methacrylic acid copolymer, an ethylene-methyl acrylate copolymer, an ethylene-methyl methacrylate copolymer or the like. They may be used alone or two or more kinds in combination. In addition, they may be cross-linked substances by Na⁺ ion or the like.

As the electric conducting material of the negative electrode mixture, any one may be used as long as it is an electron conductive material which is chemically stable in a battery. For example, there may be used graphites such as natural graphite (scale-like graphite, or the like), artificial graphite; carbon blacks such as acetylene black, Ketjen black, channel black, furnace black, lamp black, thermal black; conductive fibers such as carbon fiber, metal fiber; powders of a metal such as aluminum; conductive whiskers such as zinc oxide, potassium titanate; a conductive metal oxide such as titanium oxide; and organic conductive material such as a polyphenylene derivative; or the like. They may be used alone or two or more kinds in combination.

The addition amount of the electric conducting material is not especially limited, and it is preferably 1 to 30% by weight, and more preferably 1 to 10% by weight, relative to the negative electrode active material particle contained in the negative electrode mixture.

As the negative electrode core material (the negative electrode collector), any one may be used as long as it is an electron conductive material which is chemically stable in a battery. For example, a foil or a sheet composed of stainless steel, nickel, copper, titanium, carbon, a conductive resin or the like may be used, and among these, the copper and the copper alloy are preferable. It is also possible to furnish a carbon, titanium or nickel layer, or form an oxide layer at the surface of the foil or the sheet. In addition, it is also possible to furnish a concave-convex at the surface of the foil or the sheet, and a net, a punching sheet, a lath substance, a porous substance, a foamed substance, a fiber group compact and the like can also be used.

Thickness of the negative electrode core material is not especially limited, and, for example, 1 to 500 μm is used.

Next, as a non-aqueous electrolytic solution, a non-aqueous solvent dissolved with a lithium salt is preferable. In addition, as the non-aqueous solvent, there can be used, for example, cyclic carbonates such as ethylene carbonate (EC), propylene carbonate (PC), butylene carbonate (BC), vinylene carbonate (VC); chained carbonates such as dimethyl carbonate (DMC), diethyl carbonate (DEC), ethyl methyl carbonate (EMC), dipropyl carbonate (DPC); aliphatic carboxylate esters such as methyl formate, methyl acetate, methyl propionate, ethyl propionate; lactones such as γ-butyrolactone, γ-valerolactone; chained ethers such as 1,2-dimethoxyethane (DME), 1,2-diethoxyethane (DEE), ethoxy methoxy ethane (EME); cyclic ethers such as tetrahydrofuran, 2-methyltetrahydrofuran; dimethylsulfoxide, 1,3-dioxolane, formamide, acetamide, dimethylformamide, dioxolane, acetonitrile, propylnitrile, nitromethane, ethylmonoglyme, phosphoric acid tri-ester, trimethoxymetane, dioxolane derivatives, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propane sultone, anisole, dimethylsulfoxide, N-methyl-2-pyrrolidone; or the like. These may be used alone or two or more kinds in combination. Among these, a mixed solvent of the cyclic carbonate and the chained carbonate, or a mixed solvent of the cyclic carbonate, the chained carbonate and the aliphatic carboxylate ester is preferable.

As the lithium salt, there may be included, for example, LiClO₄, LiBF₄, LiPF₆, LiAlCl₄, LiSbF₆, LiSCN, LiCl, LiCF₃SO₃, LiCF₃CO₂, Li (CF₃SO₂)₂, LiAsF₆, LiN(CF₃SO₂)₂, LiB₁₀Cl₁₀, lower aliphatic lithium carboxylate, LiCl, LiBr, LiI, chloroborane lithium, lithium tetraphenylborate, a lithium imidate salt or the like. These may be used alone or two or more kinds in combination. It should be noted that it is preferable to use at least LiPF₆.

Concentration of the lithium salt in the non-aqueous solvent is not especially limited, however, it is preferably 0.2 to 2 mol/L, and more preferably 0.5 to 1.5 mol/L.

In the non-aqueous electrolytic solution, various additives can be added to improve charge-discharge characteristics of the battery. As the additives, there may be included, for example, triethyl phosphite, triethanolamine, cyclic ether, ethylene diamine, n-glyme, pyridine, hexaphosphoric acid triamide, nitrobenzene derivatives, crown-ethers, quaternary ammonium salt, ethylene glycol dialkyl ether and the like.

In addition, between the positive electrode and the negative electrode, a separator may be intervened. As the separator, a micro porous thin membrane having large ion permeation degree and predetermined mechanical strength, as well as insulation property is preferable. As this micro porous thin membrane, the one clogging a hole at a certain temperature or higher, and having function to increase resistance is preferable. In addition, as a material of the micro porous thin membrane, polyolefin such as polypropylene, polyethylene or the like, superior in resistance to an organic solvent and having hydrophobic property is used preferably. In addition, a sheet, a nonwoven fabric, a woven fabric made of glass fiber or the like may be used as well.

As exterior diameter of the separator, it is generally set at 0.01 to 1 μm. In addition, as thickness of the separator, it is generally set at 10 to 300 μm. In addition, as void ratio of the separator, it is generally set at 30 to 80%.

Still more, a polymer electrolyte made of non-aqueous electrolytic liquid and a polymer material maintaining it can also be used as the separator, by making as one-piece substance with the positive electrode or the negative electrode. As this polymer material, any one may be used as long as it is capable of holding the non-aqueous electrolytic solution, however, a copolymer of vinylidene fluoride and hexafluoropropylene is particularly preferable.

### EXAMPLES

Explanation will be given below in further detail on the present invention with reference to Examples and Comparative Examples of the present invention, however, the present invention should not be limited by these Examples at all. It should be noted that an analysis method and an evaluation method for specific surface area for a metal of the lithium nickel composite oxide used in Examples and Comparative Examples, is as follows.

### (1) Analysis of a Metal: it was Performed by an IPC Emission Spectrometry.

### (2) Measurement of Specific Surface Area: it was Performed by a BET Method.

### Example 1

A positive electrode active material composed of a lithium nickel composite oxide was produced by the following series of steps including the step for preparing a nickel hydroxide having predetermined composition, the step for preparing fired powder having predetermined composition, and the step for water washing treatment the resultant fired powder and then drying, and still more by preparing a coin battery using this as a positive electrode material, it was evaluated using impedance.

It should be noted that each raw material was weighed so that molar ratio of each metal component of the lithium nickel composite oxide becomes Ni:Co:Al:Li=0.82:0.15:0.03:1.02.

### (1) The Step for Preparing a Nickel Hydroxide

Firstly, an aqueous solution was produced by mixing nickel sulfate hexahydrate (produced by Wako Pure Chemical Industries, Ltd.), cobalt sulfate heptahydrate (produced by Wako Pure Chemical Industries, Ltd.) and aluminum sulfate (produced by Wako Pure Chemical Industries, Ltd.), so as to attain the desired molar ratio. This aqueous solution was dropped at the same time with ammonia water (produced by Wako Pure Chemical Industries, Ltd.) and a sodium hydroxide aqueous solution (produced by Wako Pure Chemical Industries, Ltd.) into a stirring reaction chamber equipped with a discharge outlet, filled with water warmed at 50° C. At this time, by a reaction crystallization method, where pH was maintained at 11.5 and residence time was controlled so as to attain 11 hours, spherical nickel hydroxide particles, where primary particles were aggregated, were produced.

### (2) The Step for Producing Fired Powder

Lithium hydroxide-monohydrate (produced by Wako Pure Chemical Industries, Ltd.) was added to the resultant nickel hydroxide so as to attain the desired composition, and they were mixed using a V-blender. The resultant mixture was preliminary firing at 500° C. for 3 hours under atmosphere of an oxygen concentration of 30% or higher, using an electric furnace, and then it was subjected to main firing at 760° C. for 20 hours. After that, it was cooled to room temperature inside the furnace, and then performed cracking treatment to obtain spherical fired powder where primary particles were aggregated.

### (3) The Step for Water Washing and Drying the Fired Powder

Pure water of 20° C. was added to the resultant fired powder to make slurry with a concentration of 1200 g/L, which was stirred for 50 minutes and washed with water, and then it was filtered, and powder taken out was stood still for 10 hours using a vacuum drying machine warmed at 150° C. Here, the upper limit of the slurry concentration in the formula (4) is 1700 g/L, and 1200 g/L is within a range of the formula (4). After that, analysis of composition and measurement of specific surface area of powder of the lithium nickel composite oxide were performed. In addition, the lithium nickel composite oxide was confirmed to be a single phase, by powder X-ray diffraction using Cu—Kα ray. Results are shown in Table 2.

### (4) Preparation and Evaluation of a Battery

A battery was prepared by the following method, using the resultant lithium nickel composite oxide, and inner resistance was measured by impedance of the battery. Measurement results are shown in Table 2.

### [A Preparation Method of a Battery]

To 90 parts by weight of the powder of the positive electrode active material, 5 parts by weight of acetylene black and 5 parts by weight of polyvinylidene fluoride were mixed, and n-methylpyrrolidone was added to make paste. This was applied onto an aluminum foil with a thickness of 20 μm, so as to attain a weight of the active material after drying of 0.05 g/cm², vacuum drying was performed at 120° C., and then a disk with a diameter of 1 cm was cut out therefrom to obtain a positive electrode.

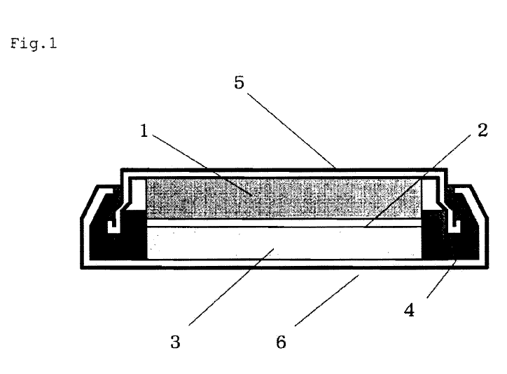

As a negative electrode, a lithium metal was used, and as an electrolytic solution, a mixed solution of ethylene carbonate (EC) and diethylene carbonate (DEC) in equal amount, containing 1M of LiClO₄ as a supporting electrolyte, was used. In addition, the electrolytic solution was infiltrated into a separator made of polyethylene to prepare a 2032-type coin battery in a glove box under Ar gas atmosphere controlled at a dew point of −80° C. FIG. 1 shows a schematic structure of the 2032-type coin battery. The coin battery here is composed of a positive electrode (electrode for evaluation) 1 in a positive electrode can 5, a lithium metal negative electrode 3 in a negative e electrode can 6, a separator 2 infiltrated with the electrolytic solution, and a gasket 4.

### [The Evaluation Method by Impedance]

The prepared battery was stood still for about 24 hours to stabilize OCV, and then CCCV charging was performed up to a voltage of 4.0 V under an initial time current density of 0.5 mA/cm², relative to a positive electrode. On the coin battery in a charged state, inner resistance value Rct was measured by an A.C. impedance method by scanning from a frequency of 10 kHz to 0.1 Hz under a voltage condition of 10 mV, using an impedance analyzer 1255B, manufactured by Solartron Co., Ltd, to evaluate it by a relative value using the value of Example 1 as 100. Measurement result is shown in Table 1.

### [The Evaluation Method by Impedance]

The prepared battery was stood still for about 24 hours to stabilize OCV, and then CCCV charging was performed up to a voltage of 4.0 V under an initial time current density of 0.5 mA/cm², relative to a positive electrode, and then impedance measurement was performed using the coin battery in a charged state, by scanning from a frequency of 10 kHz to 0.1 Hz under a voltage condition of 10 mV. An impedance device used here is an impedance analyzer 1255B, manufactured by Solartron Co., Ltd.

In addition, inner resistance value Rct described in Table 1 is the one calculated from the second arc after measurement, and expressed as a relative value to value of Example 1 as 100.

### [Measurement of Amount of Lithium at the Surface]

Ultra pure water was added up to 100 ml to 10 g of powder of a lithium nickel composite oxide, followed by stirring and titration with 1 mol/L of hydrochloric acid to measure up to the second neutralization point. By assuming an alkaline component neutralized with hydrochloric acid, as lithium at the surface of the lithium nickel composite oxide, mass ratio of lithium, relative to the lithium nickel composite oxide, was determined from the titration result, and this value was adopted as amount of lithium at the surface. Results are shown in Table 2.

### [Measurement of Gas Generation Amount at High Temperature]

Measurement of gas generation amount was performed by standing still a battery prepared in a charged state at a high temperature of 80° C., cutting a part of an exterior packaging of the battery, and by quantitatively determining volume of gas collected by replacing on liquid in paraffin at 23° C. Results are shown in Table 2.

### Example 2

A lithium nickel composite oxide was produced by performing similarly as in Example 1, except that, instead of nickel hydroxide obtained by (1) the preparation step of nickel hydroxide of Example 1, nickel oxyhydroxide was used, which was obtained by still more oxidation treatment of nickel hydroxide by adding sodium hypochlorite. Results of measuring composition, amount of lithium at the surface, and specific surface area of the resultant powder, as well as impedance and generation amount of gas during storage at high temperature of the battery are shown in Tables 1 and 2. It should be noted that nickel the resultant lithium nickel composite oxide was confirmed to be a single phase of the lithium nickel composite oxide, by powder X-ray diffraction using Cu—Kα ray.

### Example 3

A lithium nickel composite oxide was produced by performing similarly as in Example 1, except that, nickel hydroxide obtained by (1) the preparation step of nickel hydroxide of Example 1, was oxidation roasted at 900° C. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 4

A lithium nickel composite oxide was produced similarly as in Example 3, except that preparation of an aqueous solution of raw materials was prepared by mixing nickel sulfate hexahydrate (produced by Wako Pure Chemical Industries, Ltd.), cobalt sulfate heptahydrate (produced by Wako Pure Chemical Industries, Ltd.), aluminum sulfate (produced by Wako Pure Chemical Industries, Ltd.), and magnesium sulfate heptahydrate (produced by Pure Chemical Co., Ltd.), so that molar ratio of each metal component of the lithium nickel composite oxide after firing becomes Ni:Co:Al:Mg:Li=0.804:0.148:0.036:0.012:1.02. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 5

A lithium nickel composite oxide was obtained similarly as in Example 3, except that preparation of an aqueous solution of raw materials was prepared by mixing nickel sulfate hexahydrate (produced by Wako Pure Chemical Industries, Ltd.), cobalt sulfate heptahydrate (produced by Wako Pure Chemical Industries, Ltd.), aluminum sulfate (produced by Wako Pure Chemical Industries, Ltd.), and manganese sulfate pentahydrate (produced by Pure Chemical Co., Ltd.), so that molar ratio of each metal component of the lithium nickel composite oxide after firing becomes Ni:Co:Al:Mn:Li=0.786:0.151:0.035:0.028:1.02. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 6

A lithium nickel composite oxide was obtained similarly as in Example 3, except that lithium oxide was used instead of lithium hydroxide-monohydrate described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 7

A lithium nickel composite oxide was obtained similarly as in Example 3, except that temperature of main firing in the firing was set at 650° C., in the preparation step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 8

A lithium nickel composite oxide was obtained similarly as in Example 3, except that temperature of main firing in the firing was set at 850° C., in the preparation step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 9

A lithium nickel composite oxide was obtained similarly as in Example 3, except that temperature of pure water used in water washing was set at 15° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 10

A lithium nickel composite oxide was obtained similarly as in Example 3, except that temperature of pure water used in water washing was set at 30° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 11

A lithium nickel composite oxide was obtained similarly as in Example 3, except that temperature of pure water used in water washing was set at 35° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 12

A lithium nickel composite oxide was obtained similarly as in Example 3, except that temperature of pure water used in water washing was set at 12° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 13

A lithium nickel composite oxide was obtained similarly as in Example 3, except that temperature of pure water used in water washing was set at 38° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 14

A lithium nickel composite oxide was obtained similarly as in Example 3, except that temperature of pure water used in water washing was set at 10° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 15

A lithium nickel composite oxide was obtained similarly as in Example 3, except that temperature of pure water used in water washing was set at 40° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 16

A lithium nickel composite oxide was obtained similarly as in Example 3, except that pure water was added to become concentration of fired powder of 500 g/L, in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Example 17

A lithium nickel composite oxide was obtained similarly as in Example 3, except that pure water was added to become concentration of fired powder of 1700 g/L, in the water washing and drying step for fired powder described in Example 1. Composition, amount of lithium at the surface, and specific surface area of the resultant powder, as well as impedance and generation amount of gas during storage at high temperature of the battery were measured. Here, 1700 g/L is the upper limit value of slurry concentration in the formula (4). Measurement results are shown in Tables 1 and 2. It should be noted that the resultant lithium nickel composite oxide was confirmed to be a single phase of the lithium nickel composite oxide, by powder X-ray diffraction using Cu—Kα ray.

### Example 18

A lithium nickel composite oxide was obtained similarly as in Example 3, except that pure water was added to become concentration of fired powder of 1800 g/L, in the water washing and drying step for fired powder described in Example 1. Composition, amount of lithium at the surface, and specific surface area of the resultant powder, as well as impedance and generation amount of gas during storage at high temperature of the battery were measured. Here, the upper limit in the formula (4) is 1700 g/L, and a slurry concentration of 1800 g/L is over the upper limit of the formula (4). Measurement results are shown in Tables 1 and 2. It should be noted that the resultant lithium nickel composite oxide was confirmed to be a single phase of the lithium nickel composite oxide, by powder X-ray diffraction using Cu—Kα ray.

### Example 19

A lithium nickel composite oxide was obtained similarly as in Example 3, except that weighing and preparation were performed so that molar ratio of each metal component of the lithium nickel composite oxide after firing becomes Ni:Co:Al:Li=0.82:0.15:0.031:1.10, and pure water was added to become concentration of fired powder of 500 g/L, in the water washing and drying step for the resultant fired powder. Composition, amount of lithium at the surface, and specific surface area of the resultant powder, as well as impedance and generation amount of gas during storage at high temperature of the battery were measured. Measurement results are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 1

A lithium nickel composite oxide was obtained similarly as in Example 3, except that temperature of pure water used in water washing was set at 0° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 2

A lithium nickel composite oxide was obtained similarly as in Example 3, except that temperature of pure water used in water washing was set at 50° C., in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 3

A lithium nickel composite oxide was obtained similarly as in Example 3, except that pure water was added to become concentration of fired powder of 2500 g/L, in the water washing and drying step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 4

A lithium nickel composite oxide was obtained similarly as in Example 3, except that weighing and preparation were performed so that molar ratio of each metal component of the lithium nickel composite oxide after firing becomes Ni:Co:Al:Li=0.82:0.15:0.031:0.94. Composition, amount of lithium at the surface, and specific surface area of the resultant powder, as well as impedance and generation amount of gas during storage at high temperature of the battery were measured. Measurement results are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 5

A lithium nickel composite oxide was obtained similarly as in Example 3, except that weighing and preparation were performed so that molar ratio of each metal component of the lithium nickel composite oxide after firing becomes Ni:Co:Al:Li=0.82:0.15:0.031:1.15, and pure water was added to become concentration of fired powder of 1200 g/L, in the water washing and drying step for the resultant fired powder. Composition, amount of lithium at the surface, and specific surface area of the resultant powder, as well as impedance and generation amount of gas during storage at high temperature of the battery were measured. Measurement results are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 6

A lithium nickel composite oxide was obtained similarly as in Example 3, except that temperature of main firing in the firing was set at 600° C., in the preparation step for fired powder described in Example 1. Results of measuring composition, amount of lithium at the surface, and specific surface area of the resultant powder, as well as impedance and generation amount of gas during storage at high temperature of the battery are shown in Tables 1 and 2. It should be noted that the resultant lithium nickel composite oxide was confirmed to be a single phase of the lithium nickel composite oxide, by powder X-ray diffraction using Cu—Kα ray.

### Comparative Example 7

A lithium nickel composite oxide was obtained similarly as in Example 3, except that temperature of main firing in the firing was set at 1000° C., in the preparation step for fired powder described in Example 1. Composition, amount of lithium at the surface, and specific surface area of the resultant powder, as well as impedance and generation amount of gas during storage at high temperature of the battery were measured. It should be noted that the resultant lithium nickel composite oxide was confirmed to be a single phase of the lithium nickel composite oxide, by powder X-ray diffraction using Cu—Kα ray. Results are shown in Tables 1 and 2.

TABLE 1

| | | | | Firing | Water washing | Slurry |
|---|---|---|---|---|---|---|
| | Raw material form | Chemical composition | Li raw | temperature | temperature | concentration |
| | of nickel oxide | after firing | material | (° C.) | (° C.) | (g/L) |
| Example 1 | Nickel hydroxide | Li_{1.02}Ni_{0.02}Co_{0.13}Al_{0.03}O₂ | LiOH•H₂O | 760 | 20 | 1200 |
| Example 2 | Nickel oxyhydroxide | Li_{1.02}Ni_{0.02}Co_{0.13}Al_{0.03}O₂ | LiOH•H₂O | 760 | 20 | 1200 |
| Example 3 | Nickel oxide | Li_{1.02}Ni_{0.02}Co_{0.13}Al_{0.03}O₂ | LiOH•H₂O | 760 | 20 | 1200 |
| Example 4 | Nickel oxide | Li_{1.02}Ni_{0.054}Co_{0.140}Al_{0.030}Mg_{0.017}O₂ | LiOH•H₂O | 760 | 20 | 1200 |
| Example 5 | Nickel oxide | Li_{1.02}Ni_{0.02}Co_{0.13}Al_{0.030}Mn_{0.020}O₂ | LiOH•H₂O | 760 | 20 | 1200 |
| Example 6 | Nickel oxide | Li_{1.02}Ni_{0.02}Co_{0.13}Al_{0.03}O₂ | Li₂O | 760 | 20 | 1200 |
| Example 7 | Nickel oxide | Li_{1.02}Ni_{0.02}Co_{0.13}Al_{0.03}O₂ | LiOH•H₂O | 650 | 20 | 1200 |
| Example 8 | Nickel oxide | Li_{1.02}Ni_{0.02}Co_{0.14}Al_{0.03}O₂ | LiOH•H₂O | 850 | 20 | 1200 |
| Example 9 | Nickel oxide | Li_{1.02}Ni_{0.02}Co_{0.16}Al_{0.03}O₂ | LiOH•H₂O | 760 | 15 | 1200 |
| Example 10 | Nickel oxide | Li_{1.02}Ni_{0.02}Co_{0.13}Al_{0.03}O₂ | LiOH•H₂O | 760 | 30 | 1200 |
| Example 11 | Nickel oxide | Li_{1.02}Ni_{0.02}Co_{0.13}Al_{0.03}O₂ | LiOH•H₂O | 760 | 35 | 1200 |
| Example 12 | Nickel oxide | Li_{1.02}Ni_{0.02}Co_{0.13}Al_{0.03}O₂ | LiOH•H₂O | 760 | 12 | 1200 |
| Example 13 | Nickel oxide | Li_{1.02}Ni_{0.02}Co_{0.13}Al_{0.03}O₂ | LiOH•H₂O | 760 | 38 | 1200 |
| Example 14 | Nickel oxide | Li_{1.02}Ni_{0.02}Co_{0.13}Al_{0.03}O₂ | LiOH•H₂O | 760 | 10 | 1200 |
| Example 15 | Nickel oxide | Li_{1.02}Ni_{0.02}Co_{0.13}Al_{0.03}O₂ | LiOH•H₂O | 760 | 40 | 1200 |
| Example 16 | Nickel oxide | Li_{1.02}Ni_{0.02}Co_{0.13}Al_{0.03}O₂ | LiOH•H₂O | 760 | 20 | 500 |
| Example 17 | Nickel oxide | Li_{1.02}Ni_{0.02}Co_{0.13}Al_{0.03}O₂ | LiOH•H₂O | 760 | 20 | 1700 |
| Example 18 | Nickel oxide | Li_{1.02}Ni_{0.02}Co_{0.13}Al_{0.03}O₂ | LiOH•H₂O | 760 | 20 | 1800 |
| Example 19 | Nickel oxide | Li_{1.10}Ni_{0.02}Co_{0.13}Al_{0.03}O₂ | LiOH•H₂O | 760 | 20 | 500 |
| Comparable | Nickel oxide | Li_{1.02}Ni_{0.02}Co_{0.13}Al_{0.03}O₂ | LiOH•H₂O | 760 | 0 | 1200 |
| Example 1 | | | | | | |
| Comparable | Nickel oxide | Li_{1.02}Ni_{0.02}Co_{0.13}Al_{0.03}O₂ | LiOH•H₂O | 760 | 50 | 1200 |
| Example 2 | | | | | | |
| Comparable | Nickel oxide | Li_{1.02}Ni_{0.02}Co_{0.13}Al_{0.03}O₂ | LiOH•H₂O | 760 | 20 | 2500 |
| Example 3 | | | | | | |
| Comparable | Nickel oxide | Li_{0.90}Ni_{0.02}Co_{0.13}Al_{0.03}O₂ | LiOH•H₂O | 760 | 20 | 1200 |
| Example 4 | | | | | | |
| Comparable | Nickel oxide | Li_{1.13}Ni_{0.02}Co_{0.13}Al_{0.03}O₂ | LiOH•H₂O | 760 | 20 | 1200 |
| Example 5 | | | | | | |
| Comparable | Nickel oxide | Li_{1.02}Ni_{0.02}Co_{0.13}Al_{0.03}O₂ | LiOH•H₂O | 600 | 20 | 1200 |
| Example 6 | | | | | | |
| Comparable | Nickel oxide | LixNiyCozAl(1 − y − z)O2* impurity | LiOH•H₂O | 1000 | 20 | 1200 |
| Example 7 | | phase | | | | |

TABLE 2

| | | | | Initial | | Gas generation |
|---|---|---|---|---|---|---|
| | | Specific | | discharge | Amount of | amount at high |
| | | surface area | Resistance Ret | capacity | surface Li | temperature |
| | Chemical composition | (m²/g) | (a.u.) | (mAh/g) | (% by mass) | (index) |
| Example 1 | Li_{0.41}Ni_{0.92}Co_{0.17}Al_{0.03}O₂ | 2.00 | 100 | 187 | 0.03 | 5 |
| Example 2 | Li_{0.61}Ni_{0.02}Co_{0.13}Al_{0.03}O₂ | 0.83 | 99 | 187 | 0.03 | 5 |
| Example 3 | Li_{0.91}Ni_{0.92}Co_{0.13}Al_{0.03}O₂ | 1.50 | 97 | 186 | 0.03 | 5 |
| Example 4 | Li_{0.412}Ni_{0.695}Co_{0.166}Al_{0.060}Mg_{0.013}O₂ | 0.69 | 98 | 186 | 0.03 | 5 |
| Example 5 | Li_{0.91}Ni_{0.92}Co_{0.17}Al_{0.03}Mn_{0.02}O₂ | 0.64 | 101 | 186 | 0.03 | 5 |
| Example 6 | Li_{0.91}Ni_{0.92}Co_{0.17}Al_{0.03}O₂ | 0.52 | 99 | 188 | 0.03 | 5 |
| Example 7 | Li_{0.91}Ni_{0.92}Co_{0.18}Al_{0.03}O₂ | 1.30 | 102 | 186 | 0.03 | 5 |
| Example 8 | Li_{0.91}Ni_{0.92}Co_{0.16}Al_{0.03}O₂ | 0.69 | 105 | 186 | 0.03 | 5 |
| Example 9 | Li_{0.41}Ni_{0.92}Co_{0.16}Al_{0.03}O₂ | 1.12 | 98 | 188 | 0.04 | 7 |
| Example 10 | Li_{0.91}Ni_{0.92}Co_{0.17}Al_{0.03}O₂ | 1.29 | 103 | 185 | 0.035 | 6 |
| Example 11 | Li_{0.91}Ni_{0.92}Co_{0.17}Al_{0.03}O₂ | 1.49 | 109 | 185 | 0.04 | 7 |
| Example 12 | Li_{0.91}Ni_{0.92}Co_{0.17}Al_{0.03}O₂ | 1.12 | 120 | 182 | 0.06 | 8 |
| Example 13 | Li_{0.91}Ni_{0.92}Co_{0.17}Al_{0.03}O₂ | 1.52 | 115 | 182 | 0.06 | 8 |
| Example 14 | Li_{0.91}Ni_{0.92}Co_{0.17}Al_{0.03}O₂ | 1.11 | 134 | 180 | 0.09 | 10 |
| Example 15 | Li_{0.91}Ni_{0.92}Co_{0.17}Al_{0.03}O₂ | 1.56 | 120 | 180 | 0.09 | 10 |
| Example 16 | Li_{0.96}Ni_{0.97}Co_{0.16}Al_{0.04}O₂ | 2.48 | 132 | 181 | 0.01 | 3 |
| Example 17 | Li_{0.92}Ni_{0.92}Co_{0.17}Al_{0.03}O₂ | 1.30 | 90 | 187 | 0.04 | 7 |
| Example 18 | Li_{0.93}Ni_{0.92}Co_{0.27}Al_{0.03}O₂ | 1.09 | 88 | 188 | 0.07 | 9 |
| Example 19 | Li_{0.91}Ni_{0.92}Co_{0.17}Al_{0.03}O₂ | 1.08 | 85 | 190 | 0.09 | 10 |
| Comparable | Li_{0.91}Ni_{0.92}Co_{0.17}Al_{0.03}O₂ | 1.11 | 130 | 135 | 0.11 | 12 |
| Example 1 | | | | | | |
| Comparable | Li_{0.41}Ni_{0.92}Co_{0.17}Al_{0.03}O₂ | 1.57 | 150 | 160 | 0.11 | 12 |
| Example 2 | | | | | | |
| Comparable | Li_{1.00}Ni_{0.03}Co_{0.14}Al_{0.03}O₂ | 0.98 | 160 | 175 | 0.13 | 14 |
| Example 3 | | | | | | |
| Comparable | Li_{0.44}Ni_{0.92}Co_{0.17}Al_{0.03}O₂ | 1.31 | 151 | 173 | 0.01 | 5 |
| Example 4 | | | | | | |
| Comparable | Li_{1.07}Ni_{0.92}Co_{0.17}Al_{0.03}O₂ | 0.78 | 84 | 191 | 0.14 | 13 |
| Example 5 | | | | | | |
| Comparable | Li_{0.91}Ni_{0.92}Co_{0.17}Al_{0.03}O₂ | 1.99 | 140 | 174 | 0.11 | 12 |
| Example 6 | | | | | | |
| Comparable | LixNiyCozAl(1 − y − z)O2* | 2.15 | 196 | 120 | 0.03 | 5 |
| Example 7 | impurity phase | | | | | |

From Tables 1 and 2, it is understood that Examples 1 to 19, which satisfy all of the requirements of the present invention, provide the positive electrode active material with low internal resistance, high capacity and less generation amount of gas at high temperature.

On the contrary, in Comparative Example 1, not satisfying a part of or all of the requirements of the present invention, due to low temperature in water washing, water washing is not sufficient, resulting in a large quantity of lithium at the surface and significant increase in internal resistance. In addition, Comparative Example 2, due to high temperature in water washing, increased elution of lithium in water washing, decreased amount of lithium at the surface, decreased capacity, as well as increased internal resistance. Still more, in Comparative Example 3, due to high slurry concentration and insufficient water washing, amount of lithium at the surface increased, internal resistance increased, as well as amount of gas generation increased at high temperature.

Still more, Comparative Example 4, due to small amount of lithium mixed, deteriorated crystallinity of the lithium nickel composite oxide, decreased capacity and also increased internal resistance, whereas, Comparative Example 5, due to high amount of lithium mixed, increased internal resistance caused by many excess lithium. In addition, Comparative Example 6, due to low firing temperature, deteriorated crystallinity of the lithium nickel composite oxide, decreased capacity and increased also internal resistance, while Comparative Example 7, due to high firing temperature, deteriorated characteristics caused by generation of a foreign phase.

### INDUSTRIAL APPLICABILITY

As is clear from the above, the positive electrode active material for the non-aqueous electrolyte secondary battery of the present invention, and the non-aqueous electrolyte secondary battery using the same are the positive electrode active material for the non-aqueous electrolyte secondary battery composed of the lithium nickel composite oxide with small internal resistance and superior heat stability, and provide the non-aqueous electrolyte secondary battery with high capacity, high safety, and suitable, with using the same, in particular, as a charge-discharge possible secondary battery utilized in a compact-type electronic device field, thus industrial applicability thereof are extremely large.

1. A positive electrode active material for non-aqueous electrolyte secondary battery comprising a lithium nickel composite oxide represented by the following general formula (1):
General formula: Li_{b}Ni₁₋ₐM1ₐO₂ (1)
(wherein M1 represents at least one kind of element selected from transition metal elements other than Ni, the second group elements and the thirteenth group elements; a satisfies 0.01≦a≦0.5; and b satisfies 0.85≦b≦1.05),
characterized in that amount of lithium of a lithium compound present at the surface of the lithium nickel composite oxide is adjusted at 0.10% by mass or lower, relative to total amount.

2. The positive electrode active material for non-aqueous electrolyte secondary battery according to claim 1, characterized in that the lithium nickel composite oxide is represented by the following general formula (2):
General formula: Li_{b}Ni_{1-x-y-z}CoₓAl_{y}M2_{z}O₂ (2)
(wherein M2 represents at least one kind of an element selected from Mn, Ti, Ca, and Mg; b satisfies 0.85≦b≦1.05; x satisfies 0.05≦x≦0.30; y is 0.01≦y≦0.1; and z satisfies 0≦z≦0.05).

3. The positive electrode active material for non-aqueous electrolyte secondary battery according to claim 1, characterized in that amount of the Lithium is 0.01 to 0.05% by mass.

4. The positive electrode active material for non-aqueous electrolyte secondary battery according to claim 1, characterized in that amount of the lithium is mass ratio of lithium relative to the lithium nickel composite oxide, which was obtained, after making slurry of the lithium nickel composite oxide by adding into a solution, and considering a lithium compound present at the surface as a total alkaline component in the slurry, determining amount of the alkaline component (the lithium compound) by titration of pH of the slurry using an acid, and then by converting to lithium therefrom.

5. The positive electrode active material for non-aqueous electrolyte secondary battery according to claim 4, characterized in that the acid is at least one kind selected from the group consisting of hydrochloric acid, sulfuric acid, nitric acid and organic acid.

6. A method for producing the positive electrode active material for non-aqueous electrolyte secondary battery according to claim 1, characterized by comprising:
(a) a step for preparing fired powder of the lithium nickel composite oxide represented by the following composition formula (3):
Composition formula: Li_{b}Ni₁₋ₐM1ₐO₂ (3)
(wherein M1 represents at least one kind of an element selected from transition metal elements other than Ni, the second group elements, and the thirteenth group elements; a satisfies 0.01≦a≦0.5; and b satisfies 0.95≦b≦1.13), by mixing at least one kind of a nickel compound selected from a nickel hydroxide containing nickel as a major component, and at least one kind of an element selected from other transition metal elements, the second group elements, and the thirteenth group elements, as a minor component, a nickel oxyhydroxide thereof, and a nickel oxide obtained by roasting them, and a lithium compound, and then firing them at the maximum temperature in a range of 650 to 850° C., under oxygen atmosphere.
(b) a step for preparing powder of the lithium nickel composite oxide by water washing treatment of the fired powder at a temperature of 10 to 40° C., and at slurry concentration sufficient for amount of lithium of the lithium compound present at the surface of the lithium nickel composite oxide to become 0.10% by mass or lower, relative to total amount, and then by filtering and drying the same.

7. The method for producing the positive electrode active material for non-aqueous electrolyte secondary battery according to claim 6, characterized in that the nickel hydroxide is prepared by dropping an aqueous solution of a metal compound which contains a nickel as a main component, and at least one kind of an element selected from other transition metal element, the second group element and the thirteenth group element as a minor component; and an aqueous solution which contains an ammonium ion supplying substance, into a reaction chamber warmed, wherein an aqueous solution of an alkali metal hydroxide, in an amount sufficient to maintain a reaction solution in an alkaline state, is dropped optionally, as appropriate.

8. The method for producing the positive electrode active material for non-aqueous electrolyte secondary battery according to claim 6, characterized in that the nickel oxyhydroxide is prepared by dropping an aqueous solution of a metal compound which contains a nickel as a main component, and at least one kind of an element selected from other transition metal element, the second group element and the thirteenth group element as a minor component; and an aqueous solution which contains an ammonium ion supplying substance, into a reaction chamber warmed, wherein an aqueous solution of an alkali metal hydroxide, in an amount sufficient to maintain a reaction solution in an alkaline state, is dropped optionally, as appropriate, and subsequently by further adding an oxidizing agent.

9. The method for producing the positive electrode active material for non-aqueous electrolyte secondary battery according to claim 6, characterized in that the lithium compound is at least one kind selected from the group consisting of a hydroxide, an oxyhydroxide, an oxide, a carbonate salt, a nitrate salt and a halide of lithium.

10. The method for producing the positive electrode active material for non-aqueous electrolyte secondary battery according to claim 6, characterized in that mixing ratio of the nickel compound and the lithium compound, in the step (a), is set so that amount of lithium in the lithium compound becomes 0.95 to 1.13 in molar ratio, relative to total amount of nickel in the nickel compound and transition metal elements other than Ni, the second group elements, and the thirteenth group elements.

11. The method for producing the positive electrode active material for non-aqueous electrolyte secondary battery according to claim 6, characterized in that amount of the fired powder, contained in slurry in water washing treatment, in the step (b), is 500 g to 2000 g, relative to 1 L of water.

12. The method for producing the positive electrode active material for non-aqueous electrolyte secondary battery according to claim 11, characterized in that amount of the fired powder contained in slurry in water washing treatment, in the step (b), satisfies the following formula (4), relative to 1 L of water:
500≦B≦−15000A+17000 (4)
(wherein A represents ratio of molar amount of lithium in the lithium compound, relative to total mole amount of nickel in the nickel oxide and transition metal elements other than Ni, the second group elements, and the thirteenth group elements, and 1.0≦A≦1.1; and B represents amount (g) of the fired powder contained in slurry, relative to 1 L of water).

13. The method for producing the positive electrode active material for non-aqueous electrolyte secondary battery according to claim 6, characterized in that, in the step (b), the fired powder after water washing treatment is dried, under gas atmosphere not containing a compound component containing carbon, or under vacuum atmosphere.

14. A non-aqueous electrolyte secondary battery comprised by using the positive electrode active material for non-aqueous electrolyte secondary battery according to claim 1.
